(19) United States
(12) Patent Application Publication
(10) Pub. No.: US 2025/0322428 A1
(43) Pub. Date: Oct. 16, 2025

(54) SYSTEMS AND METHODS FOR MANAGING A CAMPAIGN

(71) Applicant: Salesforce, Inc., San Francisco, CA (US)

(72) Inventors: Eric Wittke, Glen Ellyn, IL (US); Allison Burnett, Toronto (CA); Eric Toledo, Atlanta, GA (US); Kylie Yancey, Atlanta, GA (US); Steve Goforth, Indianapolis, IN (US); Oleg Bivol, Danville, CA (US)

(73) Assignee: Salesforce, Inc., San Francisco, CA (US)

(21) Appl. No.: 18/635,768

(22) Filed: Apr. 15, 2024

(51) Int. Cl. G06Q 30/0251; G06Q 30/0241

(52) U.S. Cl. CPC G06Q 30/0251; G06Q 30/0276

(57) ABSTRACT

A flow template user interface (UI) is generated for development of a flow of a campaign. The flow template UI is associated with a communication channel and includes an audience field, a content field, a scheduling field, and an activation field including an activation button to enable activation and deactivation of the flow. A target audience is received via the audience field, content is received via the content field, and a schedule is received via the scheduling field. A command is received to activate the flow via the activation button. The content is transmitted to the target audience via the communication channel in accordance with the schedule in response to activation of the flow.

### TECHNICAL FIELD

Embodiments of the subject matter described herein relate generally campaigns and more particularly, embodiments of the subject matter relate to management of campaigns.

### BACKGROUND

Management of campaigns is often a complicated process due to the many moving pieces, people, and processes. Campaigns are typically composed of multiple different flows. The flows may include one or more campaign assets that are developed by different software developers with different development timelines. Different flows may include different formats, target different audiences, and employ different communication channels to communicate with the target audiences. Individual flows of the campaign may be activated and deployed at different times. As a result, the development of the flows of a campaign and tracking the performance of the different flows can be a challenging and complex process.

Accordingly, there is a need in the art for a method and system for managing a campaign.

### BRIEF DESCRIPTION OF THE DRAWINGS

The present disclosure will hereinafter be described in conjunction with the following drawing figures, wherein like numerals denote like elements, and wherein:

FIG. 1 is a block diagram representation of a system including a campaign management system in accordance with at least one embodiment;

FIG. 2 is an illustration of an exemplary campaign initiation user interface in accordance with at least one embodiment;

FIG. 3 is an illustration of an exemplary flow creation selection user interface in accordance with at least one embodiment;

FIG. 4 is illustration of an exemplary flow template selection user interface in accordance with at least one embodiment;

FIG. 5 is illustration of an exemplary single short message service (SMS) flow template user interface in accordance with at least one embodiment;

FIG. 6 is an illustration of an exemplary single email flow template user interface in accordance with at least one embodiment;

FIG. 7 is an illustration of an exemplary campaign assets user interface in accordance with at least one embodiment;

FIG. 8 is an illustration of an exemplary flow status user interface of an activated multi-channel flow of a campaign in accordance with at least one embodiment;

FIG. 9 is an illustration of an exemplary flow status user interface of an activated flow of a campaign in accordance with at least one embodiment;

FIG. 10 is an exemplary illustration of a campaign summary user interface of a campaign in accordance with at least one embodiment;

FIG. 11 is a flow chart representation of a method of managing a campaign in accordance with at least one embodiment;

FIG. 12 is a block diagram representation of an example of an environment in which an on-demand database service can be used in accordance with some implementations;

FIG. 13 is a block diagram representation of example implementations of elements of FIG. 12 and example interconnections between these elements according to some implementations; and

FIG. 14 is a diagrammatic representation of a machine in an exemplary form of a computer system within which a set of instructions, for causing the machine to perform any one or more of the methodologies discussed herein, may be executed.

### DETAILED DESCRIPTION

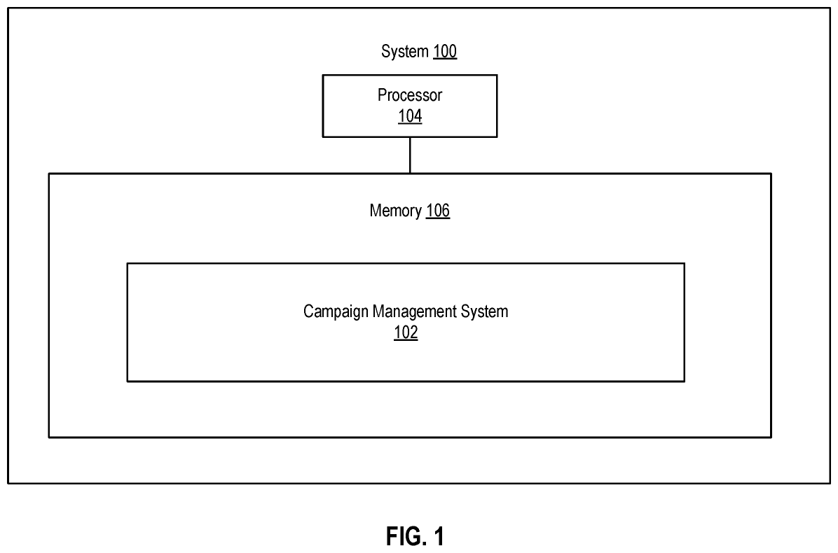

Referring to FIG. 1, a block diagram representation of a system 100 including a campaign management system 102 in accordance with at least one embodiment is shown. The system 100 includes at least one processor 104 and at least one memory 106. The at least one memory 106 is at least one non-transitory machine-readable storage medium that stores instructions configurable to be executed by the at least one processor 104. The at least one memory 106 includes the campaign management system 102. The system 100 may include additional components that facilitate operation of the campaign management system 102. It should be appreciated that FIG. 1 depicts a simplified cam representation of the campaign management system 102 for purposes of explanation and is not intended to be limiting.

A campaign typically includes a plurality of flows. Different flows may have different formats, target different audiences, and may be scheduled to go live at different times. Each of the flows of the campaign are often independently developed and include one or more campaign assets. The campaign assets may be developed independently of the development of flows and may be at different stages of development. Different flows may transmit associated content to target audiences via different communication channels. Performance metrics are often gathered and provide feedback regarding the performance of the different flows within the context of the campaign. In many instances, an assessment of the performance metrics associated with earlier released flows may warrant adjustments to flows scheduled for release at a later time to improve the effectiveness of the campaign.

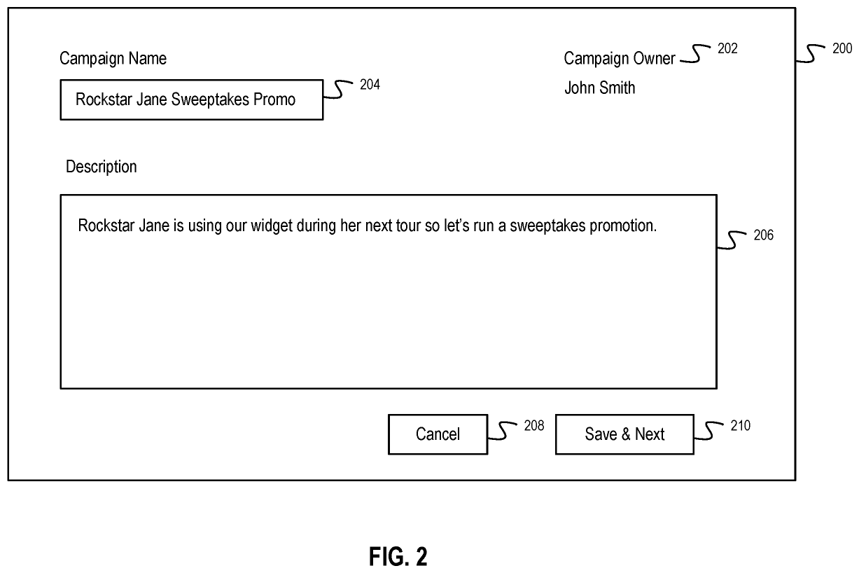

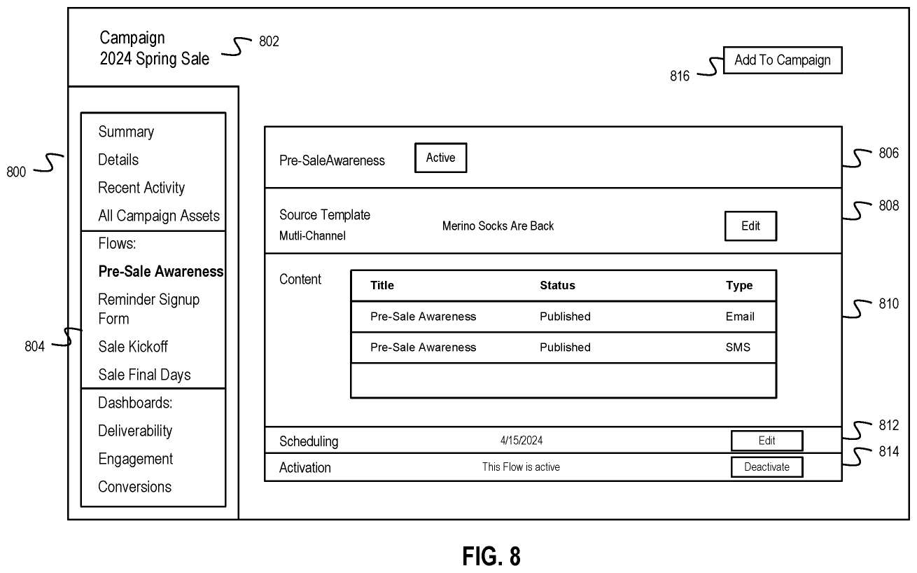

The campaign management system 102 is configured to guide a user through the development of the flows of the campaign, provide status of different flows, provide insight into the development status of campaign assets, and generate performance metrics for different flows within the campaign. The campaign management system 102 is configured to guide a user through the development of the flows of a campaign as described below with reference to FIG. 2 through FIG. 7 and to provide a status of different flows and campaign performance metrics as described with reference to FIG. 8 through FIG. 10.

Referring to FIG. 2, an illustration of an exemplary campaign initiation user interface (UI) 200 in accordance with at least one embodiment is shown. The campaign management system 102 is configured to generate the campaign initiation UI 200 for display on a display device that is communicatively coupled to the system 100. The campaign initiation UI 200 includes a campaign owner field 202, a campaign name field 204, a campaign description field 206, a cancel button 208, and a save/next button 210.

The campaign owner field 202 is automatically populated by the campaign management system 102 using a user-name associated with a user identifier used to access the campaign management system 102. For example, if a user-identifier used to access the campaign management system 102 is associated with a user-name “John Smith,” the campaign management system 102 automatically populates the campaign owner field 202 with the user-name “John Smith”.

A campaign name is received by the campaign management system 102 from the user via the campaign name field 204. The received campaign name is displayed in the campaign name field 204. For example, the campaign name “Rockstar Jane Sweepstakes Promo” may be the campaign name provided by the user and displayed in the campaign name field 204. The campaign name may be provided by the user via an input device that is communicatively coupled to the system 100.

A campaign description is received by the campaign management system 102 from the user via the campaign description field 206. The received campaign description is displayed in the campaign description field 206. For example, the campaign description “Rockstar Jane is using our widget during her next tour so let's run a sweepstake promotion” may be the campaign description provided by the user and displayed in the campaign description field 206. The campaign description may be provided by the user via the input device.

The cancel button 208 provides the user with the option of canceling the campaign. Selection of the save/next button 210 by the user, saves the user-name, the campaign name, and the campaign description and guides the user to the next step associated with the creation of the campaign. In at least one embodiment, the selection of the save/next button 210 by the user, saves the user-name, the campaign name, and the campaign description and generates a flow creation selection user interface (UI) including a plurality of flow creation options for display on the display device. While the save/next button 210 has been described as a combined save/next button, in alternative embodiments, a save button and a next button may be separate buttons.

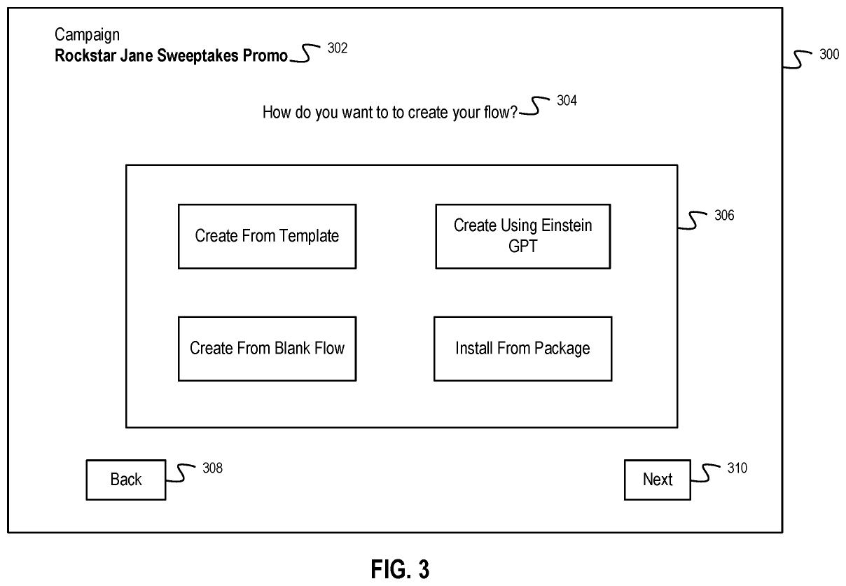

Referring to FIG. 3, an illustration of an exemplary flow creation selection user interface (UI) 300 in accordance with at least one embodiment is shown. The campaign management system 102 is configured to generate the flow creation selection UI 300 for display on the display device that is communicatively coupled to the system 100. In at least one embodiment, the campaign management system 102 is configured to generate the flow creation selection UI 300 for display on the display device responsive to the selection of the save/next button 210 on the campaign initiation UI 200. The flow creation selection UI 300 includes a campaign name field 302, a flow creation selection guidance prompt 304, a plurality of flow creation options 306, a back button 308, and a next button 310.

The campaign name field 302 is automatically populated by the campaign management system 102 using the campaign name provided by the user via the campaign name field 204 in the campaign initiation UI 200. For example, the campaign name “Rockstar Jane Sweepstakes Promo” may be the campaign name provided by the user via the campaign name field 204 in the campaign initiation UI 200.

The flow creation guidance prompt 304 provides guidance to the user to prompt the user to select one of the plurality of flow creation options 306. For example, the flow creation guidance prompt 304 may provide guidance by asking “How do you want to create your flow? to prompt the user to select one of the plurality of flow creation options 306. Examples of flow creation options 306 include, but are not limited to, create from template option, create using Einstein GPT option, create from blank flow option, and install from package option.

The back button 308 provides the user with the option of returning to the campaign initiation UI 200. Selection of the next button 310 by the user guides the user to the next step associated with the creation of the campaign. For example, selection of the “create from template” option from the plurality of flow creation options 306 followed by the selection of the next button 310 causes the campaign management system 100 to generate a flow template selection user interface (UI) for display on the display device.

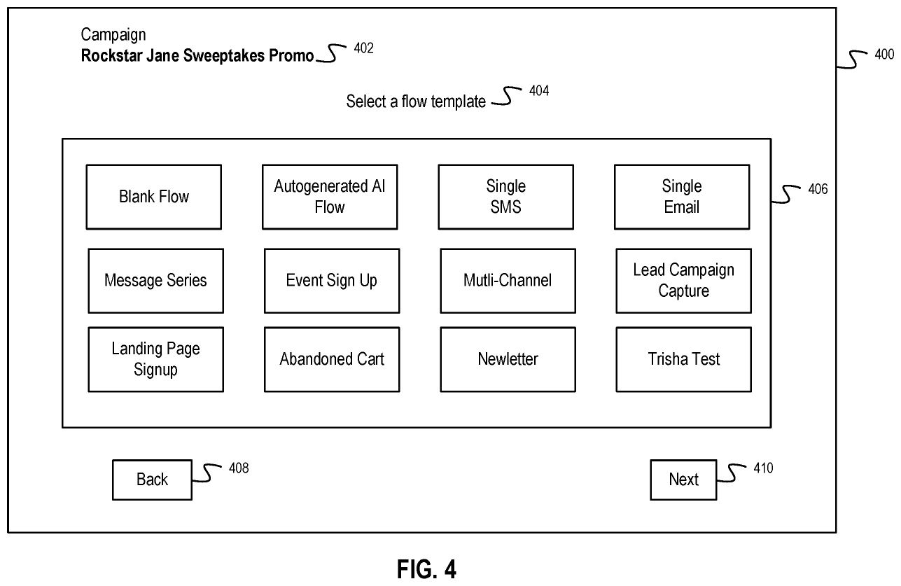

Referring to FIG. 4, an illustration of an exemplary flow template selection user interface (UI) 400 in accordance with at least one embodiment is shown. The campaign management system 102 is configured to generate the flow template selection UI 400 for display on the display device that is communicatively coupled to the system 100. In at least one embodiment, the campaign management system 102 is configured to generate the flow template selection UI 400 for display on the display device responsive to the selection of the “create from template” option from the plurality of flow creation options 306 from the flow creation selection UI 300. The flow template selection user interface (UI) 400 includes a campaign name field 402, a flow template selection guidance prompt 404, a plurality of flow templates 406, a back button 408, and a next button 410.

The campaign name field 402 is automatically populated by the campaign management system 102 using the campaign name provided by the user via the campaign name field 204 in the campaign initiation UI 200. For example, the campaign name “Rockstar Jane Sweepstakes Promo” may be the campaign name provided by the user via the campaign name field 204 in the campaign initiation UI 200.

The flow template selection guidance prompt 404 provides guidance to the user to prompt the user to select one of the plurality of flow templates 406. For example, the flow template selection guidance prompt 404 may provide guidance to “select a flow template.” Examples of flow templates 406 include, but are not limited to, a blank flow, an autogenerated artificial intelligence (AI) flow, a single short message service (SMS) flow, a single email flow, a message series flow, an event sign up flow, a multi-channel flow, a lead campaign capture flow, a landing page signup flow, an abandoned cart flow, a newsletter flow, and a Trisha test flow.

The back button 408 provides the user with the option of returning to the flow creation selection UI 300. Selection of the next button 410 by the user guides the user to the next step associated with the creation of the campaign. For example, selection of the “single SMS” flow template from the plurality of flow templates 406 followed by the selection of the next button 410 causes the campaign management system 100 to generate the single SMS flow template user interface (UI) for display on the display device.

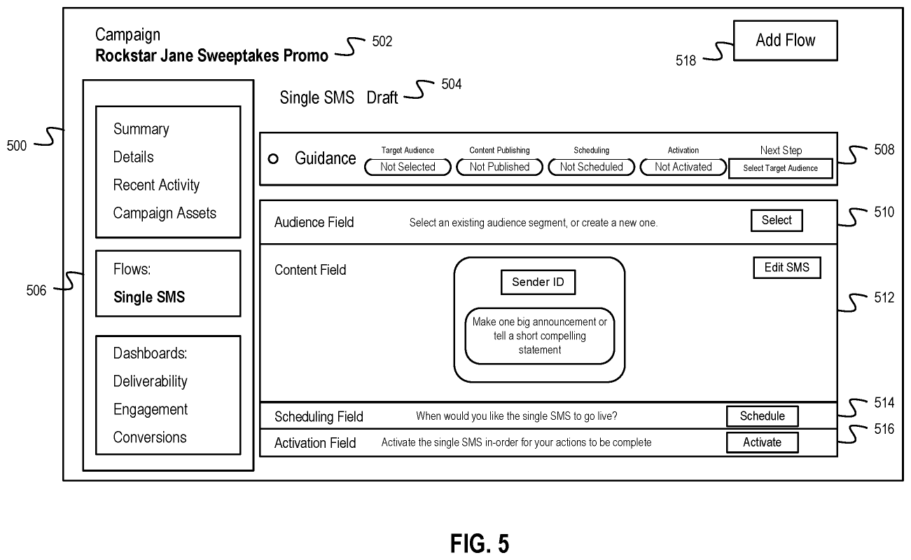

Referring to FIG. 5, an illustration of an exemplary single short message service (SMS) flow template user interface (UI) 500 in accordance with at least one embodiment is shown. The campaign management system 102 is configured to generate the single SMS flow template UI 500 for display on the display device that is communicatively coupled to the system 100. In at least one embodiment, the campaign management system 102 is configured to generate the single SMS flow template UI 500 for display on the display device responsive to the selection of the “single SMS” flow template from the plurality of flow templates 406 from the flow template selection UI 400. The single SMS flow template UI 500 includes a campaign name field 502, a template title field 504, a campaign menu 506, a flow development guidance section 508, an audience field 510, a content field 512, a scheduling field 514, an activation field 516, and an add flow button 518.

The campaign name field 502 is automatically populated by the campaign management system 102 using the campaign name provided by the user via the campaign name field 204 in the campaign initiation UI 200. For example, the campaign name “Rockstar Jane Sweepstakes Promo” may be the campaign name provided by the user via the campaign name field 204 in the campaign initiation UI 200.

The template title field 504 includes the title of the flow template selected via the flow template selection UI 400. The template title field 504 includes a status of the flow. The status of the flow may be one of draft and complete. For example, the title of the selected flow template may be single SMS. Since the single SMS flow is under development, the status of the flow is draft.

The campaign menu 506 includes a plurality of campaign displays. Responsive to the selection of a campaign display from the campaign menu 506, the campaign management system 102 generates the selected campaign display for display on the display device. In at least one embodiment, the campaign menu 506 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 506 includes a list of the flows that have been developed and/or are under development for the campaign. If a display associated with a flow is displayed on the display device, that flow is highlighted or bolded in the campaign menu 506. For example, the display on the display device is the single SMS flow template associated with the single SMS flow. Accordingly, the single SMS flow is bolded in the campaign menu 506.

In at least one embodiment, the campaign menu 506 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The flow development guidance section 508 provides a status of the flow development stages and the next step in the flow development process. In at least one embodiment, the flow development guidance section 508 provides statuses associated with whether a target audience for the flow has been selected, whether the content has been published, whether the flow has been scheduled for activation, and whether the flow has been activated. For example, the flow development guidance section 508 in the single SMS flow template UI 500 indicates that the target audience has not been selected, the content has not been published, the flow has not been scheduled for activation, and the flow has not been activated. The flow development guidance section 508 indicates that the next step in the flow development process is the selection of the target audience.

The audience field 510 includes instructions associated with the selection of the target audience for the single SMS flow. In at least one embodiment, the instructions guide the user to either select an existing audience or create a new audience as the target audience. The audience field 510 includes a select button. Activating the select button enables the user to select an existing audience as the target audience or create a new audience. In at least one embodiment, upon activation of the select button, the campaign management system 102 generates a list of available existing audiences for selection by the user. In various embodiments, the list of available existing audiences are displayed in a separate window within the single SMS flow template UI 500. In at least one embodiment, upon activation of the select button, the campaign management system 102 generates a separate window within the single SMS flow template UI 500 to enable the user to create a new audience.

The content field 512 includes instructions that guide a user with the insertion of sender identification and content into the content field and an edit SMS button. Upon activation of the edit SMS button by the user, the campaign management system 102 enables the insertion of the sender identification and the content into the content field. For example, instructions that guide the insertion of content in the content field may be “Make one big announcement or tell a short compelling statement.”

The scheduling field 514 includes instructions that guide the insertion of a schedule for the single SMS flow to go live and a schedule button. Upon activation of the schedule button by the user, the campaign management system 102 enables the insertion of a schedule for the single SMS flow to go live by the user. The schedule is in the date that the single SMS flow will go live. For example, instructions that guide the insertion of the schedule in the schedule field may be “When would you like the single SMS to go live?”.

The activation field 516 includes instructions that guide the user with the activation of the single SMS flow and an activate button. Upon selection of the activate button by the user, the campaign management system 102 activates the single SMS flow. For example, instructions that guide the activation of the single SMS flow may be “Activate the single SMS in order for your actions to be complete.” Upon the activation of the single SMS flow, the single SMS flow will go live on the scheduled date.

The add flow button 518 allows the user to add additional flows to the campaign. Upon activation of the add flow button 518, the campaign management system 102 generates the flow creation selection UI 300 for display on the display device to enable the user to select one of the flow creation options 306 for the addition of the next flow.

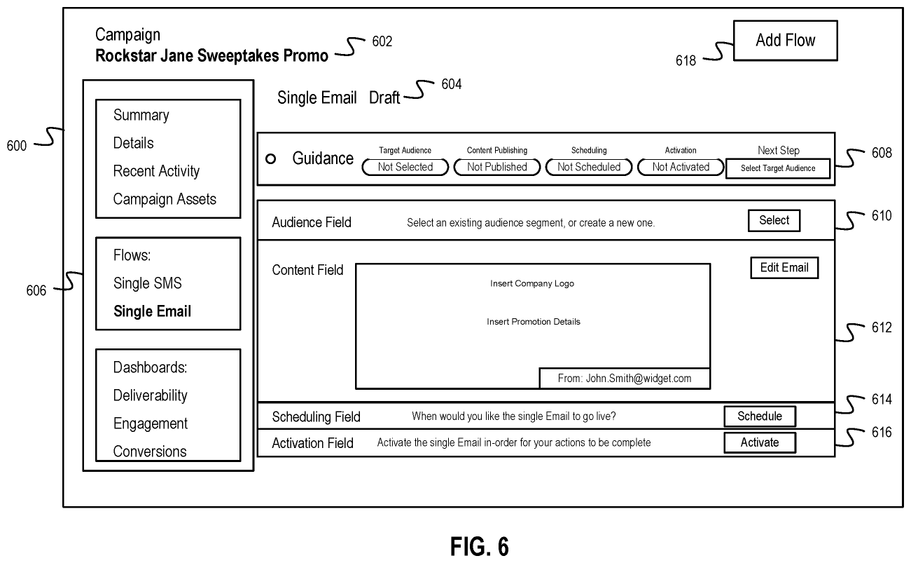

Referring to FIG. 6, an illustration of an exemplary single email flow template user interface (UI) 600 in accordance with at least one embodiment is shown. The campaign management system 102 is configured to generate the single email flow template UI 600 for display on the display device that is communicatively coupled to the system 100. In at least one embodiment, the campaign management system 102 is configured to generate the email flow template UI 600 for display on the display device responsive to the selection of the “single email” flow template from the plurality of flow templates 406 from the flow template selection UI 400. The single email flow template UI 600 includes a campaign name field 602, a template title field 604, a campaign menu 606, a flow development guidance section 608, an audience field 610, a content field 612, a scheduling field 614, an activation field 616, and an add flow button 618.

The campaign name field 602 is automatically populated by the campaign management system 102 using the campaign name provided by the user via the campaign name field 204 in the campaign initiation UI 200. For example, the campaign name “Rockstar Jane Sweepstakes Promo” may be the campaign name provided by the user via the campaign name field 204 in the campaign initiation UI 200.

The template title field 604 includes the title of the flow template selected via the flow template selection UI 400. The template title field 604 includes a status of the flow. The status of the flow may be one of draft and complete. For example, the title of the selected flow template may be single email. Since the single email flow is under development, the status of the flow is draft.

The campaign menu 606 includes a plurality of campaign displays. Responsive to the selection of a campaign display from the campaign menu 606, the campaign management system 102 generates the selected campaign display for display on the display device. In at least one embodiment, the campaign menu 606 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 606 includes a list of the flows that have been developed and/or are under development for the campaign. If a display associated with a flow is displayed on the display device, that flow is highlighted or bolded in the campaign menu 606. For example, the display on the display device is the single email flow template associated with the single email flow. Accordingly, the single email flow is bolded in the campaign menu 606.

In at least one embodiment, the campaign menu 606 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The flow development guidance section 608 provides a status of the flow development stages and the next step in the flow development process. In at least one embodiment, the flow development guidance section 608 provides statuses associated with whether a target audience for the flow has been selected, whether the content has been published, whether the flow has been scheduled for activation, and whether the flow has been activated. For example, the flow development guidance section 608 in the single email flow template UI 600 indicates that the target audience has not been selected, the content has not been published, the flow has not been scheduled for activation, and the flow has not been activated. The flow development guidance section 608 indicates that the next step in the flow development process is the selection of the target audience.

The audience field 610 includes instructions associated with the selection of the target audience for the single email flow. In at least one embodiment, the instructions guide the user to either select an existing audience or create a new audience as the target audience. The audience field 610 includes a select button. Activating the select button enables the user to select an existing audience as the target audience or create a new audience. In at least one embodiment, upon activation of the select button, the campaign management system 102 generates a list of available existing audiences for selection by the user. In various embodiments, the list of available existing audiences are displayed in a separate window within the email flow template UI 600. In at least one embodiment, upon activation of the select button, the campaign management system 102 generates a separate window within the email flow template UI 600 to enable the user to create a new audience.

The content field 612 includes instructions that guide the insertion of sender identification and content into the content field and an edit email button. Upon activation of the edit email button by the user, the campaign management system 102 enables the insertion of the sender identification and the content into the content field by the user. For example, instructions that guide the user with the insertion of content in the content field may be “Insert Company Log” and “Insert Promotion Details.”

The scheduling field 614 includes instructions that guide the user with the insertion of a schedule for the single email flow to go live and a schedule button. Upon activation of the schedule button by the user, the campaign management system 102 enables the insertion of schedule by the user for the single email flow to go live. The schedule is in the date that the single email flow will go live. For example, instructions that guide the user with the insertion of the schedule in the schedule field may be “When would you like the single email to go live?”.

The activation field 616 includes instructions that guide the user with the activation of the single email flow and an activate button. Upon selection of the activate button by the user, the campaign management system 102 activates the single email flow. For example, instructions that guide the user with the activation of the single email flow may be “Activate the single email in order for your actions to be complete.” Upon the activation of the single email flow, the single email flow will go live on the scheduled date.

The add flow button 618 allows the user to add additional flows to the campaign. Upon activation of the add flow button 618, the campaign management system 102 generates the flow creation selection UI 300 for display on the display device to enable the user to select one of the flow creation options 306 for the addition of the next flow to the campaign.

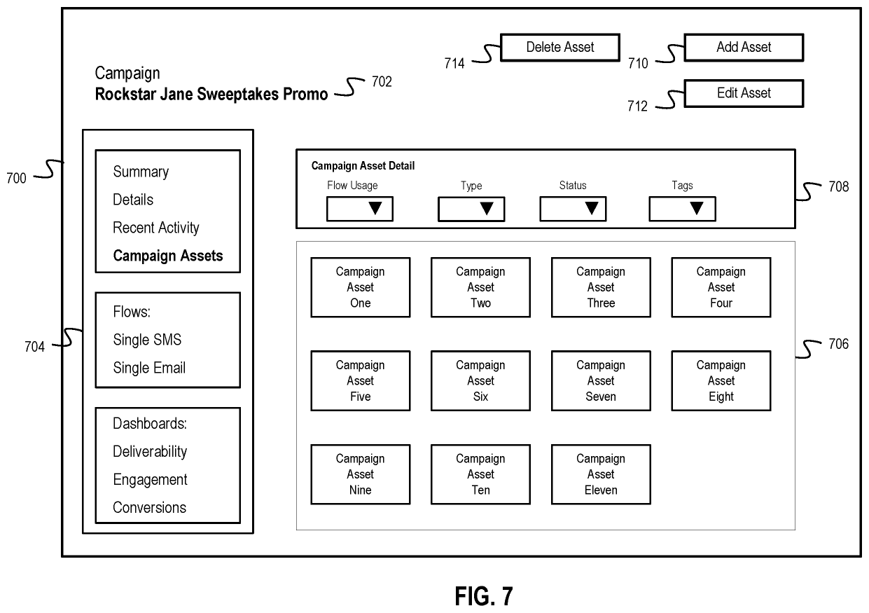

Referring to FIG. 7, an illustration of an exemplary campaign assets user interface (UI) 700 in accordance with at least one embodiment is shown. The campaign management system 102 is configured to generate the campaign assets UI 700 for display on the display device that is communicatively coupled to the system 100. In at least one embodiment, the campaign management system 102 is configured to generate the campaign assets UI 700 for display on the display device responsive to the selection to a campaign asset request. In at least one embodiment, the campaign management system 102 is configured to generate the campaign assets UI 700 for display on the display device responsive to the selection of “Campaign Assets” from the campaign menu 506, 606. The campaign assets UI 700 includes a campaign name field 702, a campaign menu 704, a plurality of campaign assets 706, campaign asset detail 708, an add asset button 710, an edit asset button 712, and a delete asset button.

The campaign name field 702 is automatically populated by the campaign management system 102 using the campaign name provided by the user via the campaign name field 204 in the campaign initiation UI 200. For example, the campaign name “Rockstar Jane Sweepstakes Promo” may be the campaign name provided by the user via the campaign name field 204 in the campaign initiation UI 200.

The campaign menu 706 includes a plurality of campaign displays. Responsive to the selection of a campaign display from the campaign menu 706, the campaign management system 102 generates the selected campaign display for display on the display device. In at least one embodiment, the campaign menu 706 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 706 includes a list of the flows that have been developed and/or are under development for the campaign. If a display from the campaign menu 706 is displayed on the display device, that item in the campaign menu 706 is highlighted or bolded in the campaign menu 706. For example, the display on the display device is the campaign assets UI 700. Accordingly, campaign assets is bolded in the campaign menu 706.

In at least one embodiment, the campaign menu 706 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The plurality of campaign assets 706 are all of the campaign assets that are designated for use in in the flows of the campaign. Examples of campaign assets include, but are not limited to images, logos, and text. The campaign assets UI 700 facilitates management of the plurality of campaign assets 706 that are designated for use in the different flows of the campaign. The plurality of campaign assets 706 that are designated for use in the different flows of the campaign are provided on a single display to enable a user to efficiently manage the campaign assets associated with the campaign.

The campaign asset detail 708 provides a user with access to additional detail associated with each of the plurality of campaign assets 706. In various embodiments, the campaign asset detail 708 provides a user with access to additional detail associated with each of the plurality of campaign assets 706 via drop down menus. The campaign asset detail 708 includes drop down menus for flow usage, type, status, and tags. The flow usage drop down menu provides information regarding the specific campaign assets used in individual flows of the campaign. The type drop down menu provides information regarding the type of each of the plurality of campaign assets. The types of campaign assets include images and text. The status drop down menu provides information regarding the development status of each of the plurality of campaign assets. The development status of a campaign asset may be, for example, in progress or complete. The tag drop down menu specifies tags associated with individual campaign assets.

The add asset button 710 allows a user to add a campaign asset to the plurality of campaign assets 706. The edit asset button 712 allows a user to select and edit one of the plurality of campaign assets 706. The delete button 714 allows a user to select and delete one of the plurality of campaign assets 706. The campaign management system 102 enables a user to select one or more of the plurality of campaign assets 706 for use in one or more flows of the campaign.

The campaign management system 102 is configured to provide a status of different flows and campaign performance metrics as described below with reference to FIG. 8 through FIG. 10. Referring to FIG. 8, an illustration of an exemplary flow status user interface 800 of an activated multi-channel flow of a campaign in accordance with at least one embodiment is shown. The multi-channel flow is communicated to target audiences via multiple communication channels. The multi-channel flow is created using the multi-channel flow template.

The campaign management system 102 is configured to generate the flow status UI 800 for a flow for display on the display device that is communicatively coupled to the system 100. In at least one embodiment, the campaign management system 102 is configured to generate the flow status UI 800 for a flow for display on the display device responsive to a flow status request for the flow. In at least one embodiment, the campaign management system 102 is configured to generate the flow status UI 800 for a flow for display on the display device responsive to the selection of that flow from the campaign menu 804. The flow status UI 800 includes a campaign name field 802, a campaign menu 804, a flow title field 806, a flow data field 808, a flow content field 810, a scheduling field 812, an activation field 814, and an add to campaign button 816.

The campaign name field 802 is automatically populated by the campaign management system 102 using the campaign name provided by the user via the campaign name field 204 in the campaign initiation UI 200. For example, the campaign name “2024 Spring Sale” may be the campaign name provided by the user via the campaign name field 204 in the campaign initiation UI 200.

The campaign menu 804 includes a plurality of campaign displays. Responsive to the selection of a campaign display from the campaign menu 804, the campaign management system 102 generates the selected campaign display for display on the display device. In at least one embodiment, the campaign menu 804 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 804 includes a list of the flows that have been developed and/or are under development for the campaign. If a display associated with a flow is displayed on the display device, that flow is highlighted or bolded in the campaign menu 804. For example, the display on the display device is a flow status UI associated with the Pre-Sale Awareness flow. Accordingly, the Pre-Sale Awareness flow is bolded in the campaign menu 804.

In at least one embodiment, the campaign menu 804 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The flow title field 806 includes the title of the flow associated with the flow status UI displayed on the display device. The flow title field 806 includes a status of the flow. The status of the flow may be one of active and inactive. For example, the title of the flow associated with the flow status UI may be “Pre-Sale Awareness”. Since the “Pre-Sale Awareness” flow has been activated, the status of the flow is shown as active.

The flow data field 808 includes information about the flow. The flow data field 808 includes a source template field. The source template field lists the flow template UI that was used in the development of the flow. For example, multi-channel flow template was used in the development of the “Pre-Sale Awareness” flow and is listed in the source template field. The flow data field 808 includes a promotion name. The promotion name is included in the communications to the target audience. For example, the promotion name is “Merino Socks Are Back.” The promotion name may, for example, be included in a header of an email or included in an SMS. The flow data field 808 includes an edit button. Upon activation of the edit button by a user, the fields in the flow data field 808 can be modified by the user.

A multi-channel flow is communicated to target audiences via multiple communication channels. The flow content field 810 includes a title of the flow, a status, and a type associated with each of the flow formats used in each of the different communication channels. For example, the content of the “Pre-Sale Awareness” flow may be communicated to the target audience via email and SMS. The title field for the email and SMS includes the name of the flow. For example, the name of the flow may be “Pre-Sale Awareness.” The status indicates the status of the each of the flow formats associated with each of the communication channels. The status is one of draft or published. For example, the status of the email flow format and the SMS flow format are both shown as published for the “Pre-Awareness” flow. The type field identifies the flow format. For example, the first flow format is identified as email and the second flow format is identified as SMS.

The scheduling field 812 includes the date that the flow will go live. For example, the “Pre-Awareness Sale” flow is scheduled to go live on Apr. 14, 2024. The emails and SMS are scheduled to be sent out to the target audience on the scheduled date.

The activation field 814 indicates whether the flow is active or inactive. If the flow is active, the activation field 814 includes a deactivate button. The user is provided with the option of deactivating the flow via the deactivate button. If the flow is inactive, the activation field 814 includes an activate button. The user is provided with the option of activating the flow via the activate button. For example, since the “Pre-Awareness Sale” flow is active, the activation field 814 includes a deactivate button.

The add to campaign button 816 allows the user to add additional flows to the campaign. In at least one embodiment, upon activation of the add to campaign button 816, the campaign management system 102 generates the flow creation selection UI 300 for display on the display device to enable the user to select one of the flow creation options 306 for the addition of a flow to the campaign.

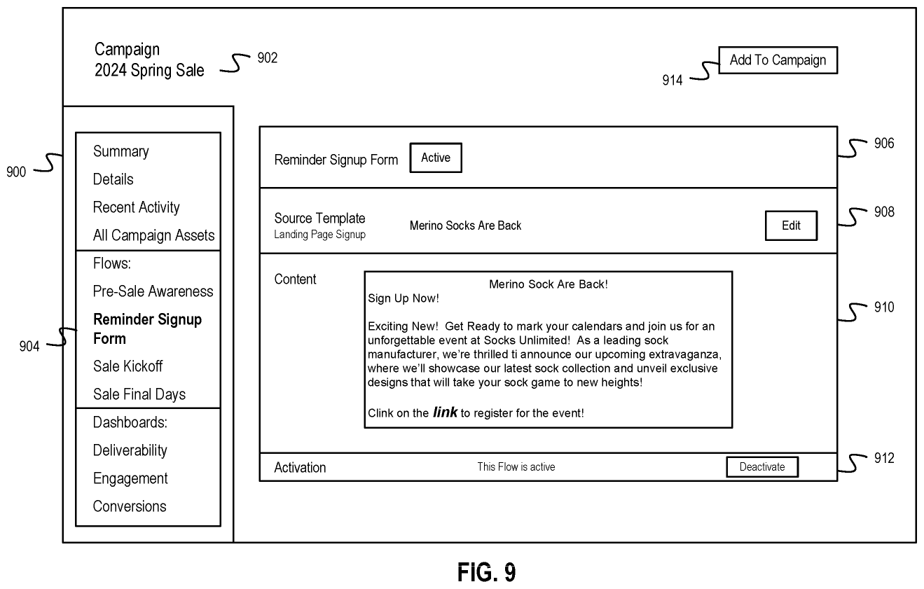

Referring to FIG. 9, an illustration of an exemplary flow status user interface 900 of an activated flow of a campaign in accordance with at least one embodiment is shown. The campaign management system 102 is configured to generate the flow status UI 900 for a flow for display on the display device that is communicatively coupled to the system 100. In at least one embodiment, the campaign management system 102 is configured to generate the flow status UI 900 for a flow for display on the display device responsive to the selection of that flow from the campaign menu 904. The flow status UI 900 includes a campaign name field 902, a campaign menu 904, a flow title field 906, a flow data field 908, a flow content field 910, an activation field 912, and an add to campaign button 914.

The campaign name field 902 is automatically populated by the campaign management system 102 using the campaign name provided by the user via the campaign name field 204 in the campaign initiation UI 200. For example, the campaign name “2024 Spring Sale” may be the campaign name provided by the user via the campaign name field 204 in the campaign initiation UI 200.

The campaign menu 904 includes a plurality of campaign displays. Responsive to the selection of a campaign display from the campaign menu 904, the campaign management system 102 generates the selected campaign display for display on the display device. In at least one embodiment, the campaign menu 904 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 904 includes a list of the flows that have been developed and/or are under development for the campaign. If a display associated with a flow is displayed on the display device, that flow is highlighted or bolded in the campaign menu 904. For example, the display on the display device is a flow status UI associated with the Reminder Signup Form flow. Accordingly, the Reminder Signup Form flow is bolded in the campaign menu 904.

In at least one embodiment, the campaign menu 904 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The flow title field 906 includes the title of the flow associated with the flow status UI displayed on the display device. The flow title field 906 includes a status of the flow. The status of the flow may be one of active and inactive. For example, the title of the flow associated with the flow status UI may be “Reminder Signup Form”. Since the “Reminder Signup Form” flow has been activated, the status of the flow is shown as active.

The flow data field 908 includes information about the flow. The flow data field 908 includes a source template field. The source template field lists the flow template UI that was used in the development of the flow. For example, landing page signup template was used in the development of the “Reminder Signup Form” flow and is listed in the source template field. The flow data field 908 includes a promotion name. The promotion name is included in the communications to the target audience. For example, the promotion name may be “Merino Socks Are Back.” The promotion name may, for example, be included in the content. The flow data field 908 includes an edit button. Upon activation of the edit button by a user, the fields in the flow data field 908 can be modified by the user.

The flow content field 910 includes the promotion name and the landing page content. For example, the promotion name may be “Merino Socks Are Back” and the landing page content includes the content for communication to the target audience.

The activation field 912 indicates whether the flow is active or inactive. If the flow is active, the activation field 912 includes a deactivate button. The user is provided with the option of deactivating the flow via the deactivate button. If the flow is inactive, the activation field 912 includes an activate button. The user is provided with the option of activating the flow via the activate button. For example, since the “Reminder Signup Form” flow is active, the activation field 912 includes a deactivate button. The flow status UI 900 does not include a scheduling field because the implementation of the flow has already been initiated and went live on the scheduled date.

The add to campaign button 914 allows the user to add additional flows to the campaign. In at least one embodiment, upon activation of the add to campaign button 914, the campaign management system 102 generates the flow creation selection UI 300 for display on the display device to enable the user to select one of the flow creation options 306 for the addition of a flow to the campaign.

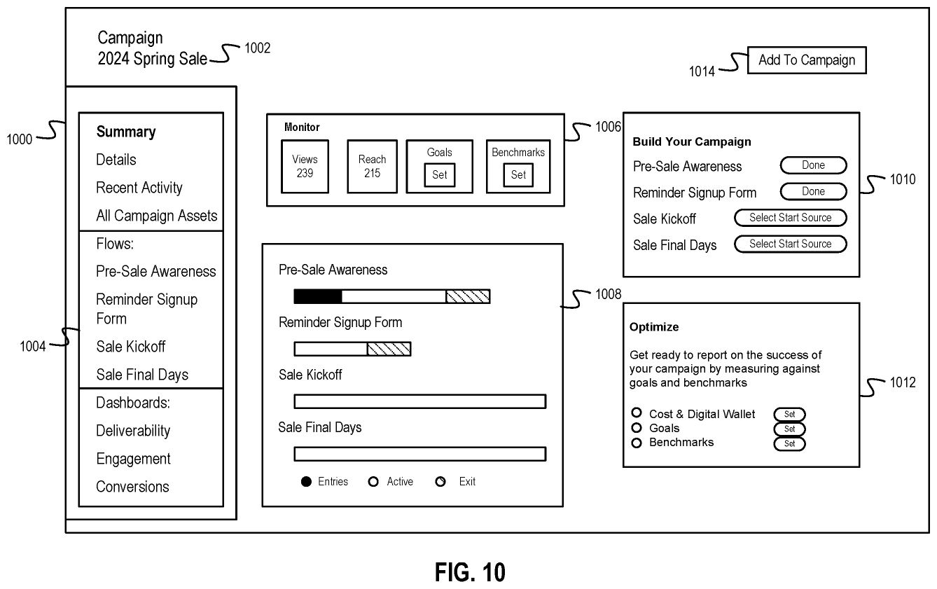

Referring to FIG. 10, an exemplary illustration of a campaign summary user interface (UI) 1000 of a campaign in accordance with at least one embodiment is shown. The campaign management system 102 is configured to generate the campaign summary UI 1000 for display on the display device that is communicatively coupled to the system 100. In at least one embodiment, the campaign management system 102 is configured to generate the campaign summary UI 1000 for display on the display device responsive to receiving a campaign summary request. In at least one embodiment, the campaign management system 102 is configured to generate the campaign summary UI 1000 for display on the display device responsive to the selection of summary from the campaign menu 804, 904, 1004. The campaign summary UI 1000 includes a campaign name field 1002, a campaign menu 1004, a campaign monitoring section 1006, a campaign flow entries/active/exit section 1008, a campaign flow development status section 1010, a campaign optimization section 1012, and an add to campaign button 1014.

The campaign name field 1002 is automatically populated by the campaign management system 102 using the campaign name provided by the user via the campaign name field 204 in the campaign initiation UI 200. For example, the campaign name “2024 Spring Sale” may be the campaign name provided by the user via the campaign name field 204 in the campaign initiation UI 200.

The campaign menu 1004 includes a plurality of campaign displays. Responsive to the selection of a campaign display from the campaign menu 1004, the campaign management system 102 generates the selected campaign display for display on the display device. In at least one embodiment, the campaign menu 1004 includes a summary display that provides a summary of the campaign, a details display that provides details associated with the campaign, a recent activity display that provides information associated with recent activities involving the campaign, and a campaign assets display that provides information regarding campaign assets used in the campaign. In various embodiments, the campaign menu 1004 includes a list of the flows that have been developed and/or are under development for the campaign. If a display selected from the campaign menu 1004 is displayed on the display device, the selected display is highlighted or bolded in the campaign menu 1004. For example, the display on the display device is a summary display that provides a summary of the campaign. Accordingly, the summary flow is bolded in the campaign menu 1004.

In at least one embodiment, the campaign menu 1004 includes a number of dashboards. Responsive to the selection of a dashboard, the campaign management system 102 generates the selected dashboard for display on the display device. Examples of dashboards include, but are not limited to, a deliverability dashboard, an engagement dashboard, and a conversions dashboard. Based on the campaign type, different analytics may be surfaced, in addition to the ability to connect custom dashboards to an individual campaign. Campaign goals and measurement benchmarks are presented in one or more of the dashboards.

The campaign monitoring section 1006 includes the number of views and the number reached by the campaign. The campaign monitoring section 1006 enables the user to set goals and benchmarks for the campaign. The campaign flow entries/active/exit section 1008 graphically represents the entries, active, and exit metrics associated with each of the flows in the campaign.

The campaign flow development status section 1010 indicates the development status of each of the flows in the campaign and provides a “select a start source” prompt for the flows where the development of the flow has not been initiated. For example, the campaign flow development status section 1010 indicates that the “Pre-Sale Awareness” flow and the “Reminder Signup Form” flow are done. The campaign flow development status section 1010 provides a “select a start source” prompt for each of the “Sale Kickoff” and the “Sale Final Days” flows. Responsive to activation of the “select a start source” prompt for either the “Sale Kickoff” flow or the “Sale Final Days” flow by the user, the campaign management system 102 generates the flow create selection UI 300 for display on the display device of the system 100. The campaign optimization section 1012 provides guidance instructions to the user with respect to reporting on the success of the campaign by measuring the campaign against goals and benchmarks. The campaign optimization section 1012 provides the user with the ability to set cost and digital wallet, goals, and benchmarks for the campaign. In various embodiments, the campaign management system 102 is configured to generates the summary page to include performance metrics associated with the responses of the target audiences to the content of each of the flows of the campaign.

The add to campaign button 1014 allows the user to add additional flows to the campaign. In at least one embodiment, upon activation of the add to campaign button 1014, the campaign management system 102 generates the flow creation selection UI 300 for display on the display device to enable the user to select one of the flow creation options 306 for the addition of a flow to the campaign.

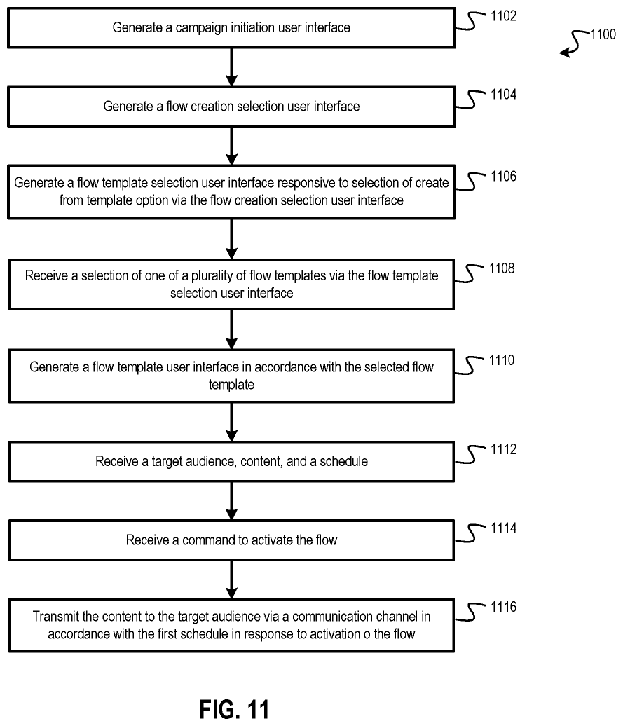

Referring to FIG. 11, a flowchart representation of an exemplary method 1100 of managing a campaign in accordance with at least one embodiment is shown. The method 1100 will be described with reference to an exemplary implementation of a campaign management system 102. As can be appreciated in light of the disclosure, the order of operation within the method 1100 is not limited to the sequential execution as illustrated in FIG. 11 but may be performed in one or more varying orders as applicable and in accordance with the present disclosure.

At 1102, the campaign management system 102 generates a campaign initiation UI 200 for display on a display device. The campaign initiation UI 200 includes a campaign owner field 202, a campaign name field 204, a campaign description field 206, and a save/next button 210. The campaign management system 102 populates the campaign owner field 202 with a user-name associated with a user identifier used to access the campaign management system 102. The campaign management system 102 receives a campaign name via the campaign name field 204 and a campaign description via the campaign description field 206.

At 1104, the campaign management system 102 generates a flow creation selection UI 300 for display on the display device responsive to selection of the save/next button 210 of the campaign initiation UI 200. The flow creation selection UI includes a plurality of flow creation options 306. The plurality of flow creation options 306 include at least two of a create from template option, a create using Einstein GPT option, a create from blank flow option, and a install from package option.

At 1106, the campaign management system 102 generates a flow template selection UI 400 for display on the display device in response to selection of the create from template option from the plurality of flow creation options 306 via the flow creation selection UI 300. The flow template selection UI 400 includes a plurality of flow templates 406. The plurality of flow templates 406 include at least two of a blank flow, an autogenerated artificial intelligence (AI) flow, a single short message service (SMS) flow, a single email flow, a message series flow, an event sign up flow, a multi-channel flow, a lead campaign capture flow, a landing page signup flow, an abandoned cart flow, a newsletter flow, and a Trisha test flow.

At 1108, the campaign management system 102 receives a selection of one of the plurality of flow templates 406 via the flow template selection UI 400. At 1110, the campaign management system 102 generates a flow template UI 500, 600 for the development of a flow in accordance with the selected one of the plurality of flow templates 406 for display on the display device. The flow template UI 500, 600 is associated with one or more communication channels and includes an audience field 510, 610, a content field 512, 612, a scheduling field 514, 614, and an activation field 516, 616 including an activation button to enable activation and deactivation of the flow.

At 1112, the campaign management system 102 receives a target audience via the audience field 510, 610, content via the content field 512, 612, and a schedule via the scheduling field 514, 614. At 1114, the campaign management system 102 receives a command to activate the flow via the activation button. At 1116, the campaign management system 102 transmits the content to the target audience via the one or more communication channels in accordance with the schedule in response to the activation of the flow.

In various embodiments, the flow template UI 500, 600 includes an add flow button 518, 618. In response to activation of the add flow button 518, 618, the campaign management system 102 generates the flow creation selection UI 300 including the plurality of flow creation options 306 for display on the display device. The campaign management system 102 receives a selection of the create from template option from the plurality of flow creation options 306 and responsively generates the flow template selection UI 400 including the plurality of flow templates 406 for display on the display device. The campaign management system 102 receives a selection of one of the plurality of flow templates 406 and generates a second flow template UI 500, 600 for the development of a second flow in accordance with the selected one of the plurality of flow templates 406 for display on the display device.

The second flow template UI 500, 600 is associated with one or more communication channels and includes an audience field 510, 610 a content field 512, 612, a scheduling field 514, 614, and an activation field 516, 616 including an activation button to enable activation and deactivation of the second flow. The campaign management system 102 receives a target audience via the audience field 510, 610, content via the content field 512, 612, and a schedule via the second scheduling field 514, 614. The campaign management system 102 receives a command to activate the second flow via the activation button. The campaign management system 102 transmits the content to the target audience via the one or more communication channels in accordance with the schedule in response to activation of the second flow. If the user wishes to add additional flows to the campaign, this process is repeated.

In various embodiments, the campaign management system 102 receives a campaign asset request and generates a campaign assets UI 700 in response to the campaign asset request for display on the display device. The campaign assets UI 700 includes a plurality of campaign assets 706 designated for use in the campaign and development statuses of the plurality of campaign assets 706.

In various embodiments, the campaign management system 102 receives a flow status request for a specific flow and generates a flow status UI 800, 900 for that flow for display on the display device. The flow status UI 800, 900 includes a source template and a status of the flow as being one of active and inactive.

In various embodiments, the campaign management system 102 receives a campaign summary request for the campaign and responsively generates a campaign summary UI 1000. The campaign summary UI 1000 includes a campaign monitoring section including a graphical representation of entries, active, and exit metrics associated with flows of the campaign and development statuses of the flows of the campaign.

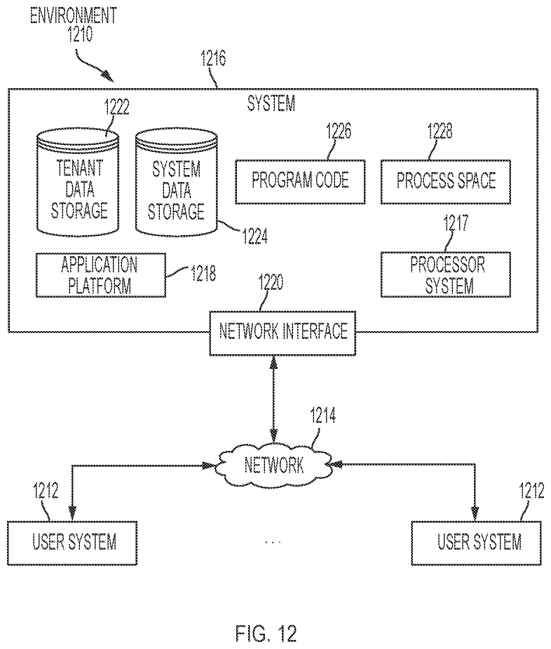

FIG. 12 shows a block diagram of an example of an environment 1210 in which an on-demand database service can be used in accordance with some implementations. The environment 1210 includes user systems 1212 (also referred to a client device), a network 1214, a database system 1216 (also referred to herein as a “cloud-based system”), a processor system 1217, an application platform 1218, a network interface 1220, tenant database 1222 for storing tenant data 1223, system database 1224 for storing system data 1225, program code 1226 for implementing various functions of the system 1216, and process space 1228 for executing database system processes and tenant-specific processes, such as running applications as part of an application hosting service. In some other implementations, environment 1210 may not have all of these components or systems, or may have other components or systems instead of, or in addition to, those listed above.

In some implementations, the environment 1210 is an environment in which an on-demand database service exists. An on-demand database service, such as that which can be implemented using the system 1216, is a service that is made available to users outside of the enterprise(s) that own, maintain or provide access to the system 1216. As described above, such users generally do not need to be concerned with building or maintaining the system 1216. Instead, resources provided by the system 1216 may be available for such users' use when the users need services provided by the system 1216; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 1218 can be a framework that allows the applications of system 1216 to execute, such as the hardware or software infrastructure of the system 1216. In some implementations, the application platform 1218 enables the creation, management and execution of one or more applications developed by the provider of the on-demand database service, users accessing the on-demand database service via user systems 1212, or third-party application users accessing the on-demand database service via user systems 1212.

In some implementations, the system 1216 implements a web-based customer relationship management (CRM) system. For example, in some such implementations, the system 1216 includes application servers configured to implement and execute CRM software applications as well as provide related data, code, forms, renderable webpages and documents and other information to and from user systems 1212 and to store to, and retrieve from, a database system related data, objects, and Webpage content. In some MTS implementations, data for multiple tenants may be stored in the same physical database object in tenant database 1222. In some such implementations, tenant data is arranged in the storage medium(s) of tenant database 1222 so that data of one tenant is kept logically separate from that of other tenants so that one tenant does not have access to another tenant's data, unless such data is expressly shared. The system 1216 also implements applications other than, or in addition to, a CRM application. For example, the system 1216 can provide tenant access to multiple hosted (standard and custom) applications, including a CRM application. User (or third-party user) applications, which may or may not include CRM, may be supported by the application platform 1218. The application platform 1218 manages the creation and storage of the applications into one or more database objects and the execution of the applications in one or more virtual machines in the process space of the system 1216.

According to some implementations, each system 1216 is configured to provide webpages, forms, applications, data and media content to user (client) systems 1212 to support the access by user systems 1212 as tenants of system 1216. As such, system 1216 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 1214 can be or include any network or combination of networks of systems or devices that communicate with one another. For example, the network 1214 can be or include any one or any combination of a LAN (local area network), WAN (wide area network), telephone network, wireless network, cellular network, point-to-point network, star network, token ring network, hub network, or other appropriate configuration. The network 1214 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 1212 can communicate with system 1216 using TCP/IP and, at a higher network level, other common Internet protocols to communicate, such as HTTP, FTP, AFS, WAP, etc. In an example where HTTP is used, each user system 1212 can include an HTTP client commonly referred to as a “web browser” or simply a “browser” for sending and receiving HTTP signals to and from an HTTP server of the system 1216. Such an HTTP server can be implemented as the sole network interface 1220 between the system 1216 and the network 1214, but other techniques can be used in addition to or instead of these techniques. In some implementations, the network interface 1220 between the system 1216 and the network 1214 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 1212 can be implemented as any computing device(s) or other data processing apparatus or systems usable by users to access the database system 1216. For example, any of user systems 1212 can be a desktop computer, a workstation, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 1212 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 1216) of the user system 1212 to access, process and view information, pages and applications available to it from the system 1216 over the network 1214.

Each user system 1212 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 1212 in conjunction with pages, forms, applications and other information provided by the system 1216 or other systems or servers. For example, the user interface device can be used to access data and applications hosted by system 1216, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 1212 may differ in their respective capacities, and the capacity of a particular user system 1212 can be entirely determined by permissions (permission levels) for the current user of such user system. For example, where a salesperson is using a particular user system 1212 to interact with the system 1216, that user system can have the capacities allotted to the salesperson. However, while an administrator is using that user system 1212 to interact with the system 1216, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 1212 and some or all of its components are operator-configurable using applications, such as a browser, including computer code executed using a central processing unit (CPU) such as an Intel Pentium® processor or the like. Similarly, the system 1216 (and additional instances of an MTS, where more than one is present) and all of its components can be operator-configurable using application(s) including computer code to run using the processor system 1217, which may be implemented to include a CPU, which may include an Intel Pentium® processor or the like, or multiple CPUs.

The system 1216 includes tangible computer-readable media having non-transitory instructions stored thereon/in that are executable by or used to program a server or other computing system (or collection of such servers or computing systems) to perform some of the implementation of processes described herein. For example, computer program code 1226 can implement instructions for operating and configuring the system 1216 to intercommunicate and to process webpages, applications and other data and media content as described herein. In some implementations, the computer code 1226 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, JAVA®, JAVASCRIPT®, ActiveX®, any other scripting language, such as VBScript®, and many other programming languages as are well known may be used. (JAVA™ is a trademark of Sun Microsystems, Inc.).

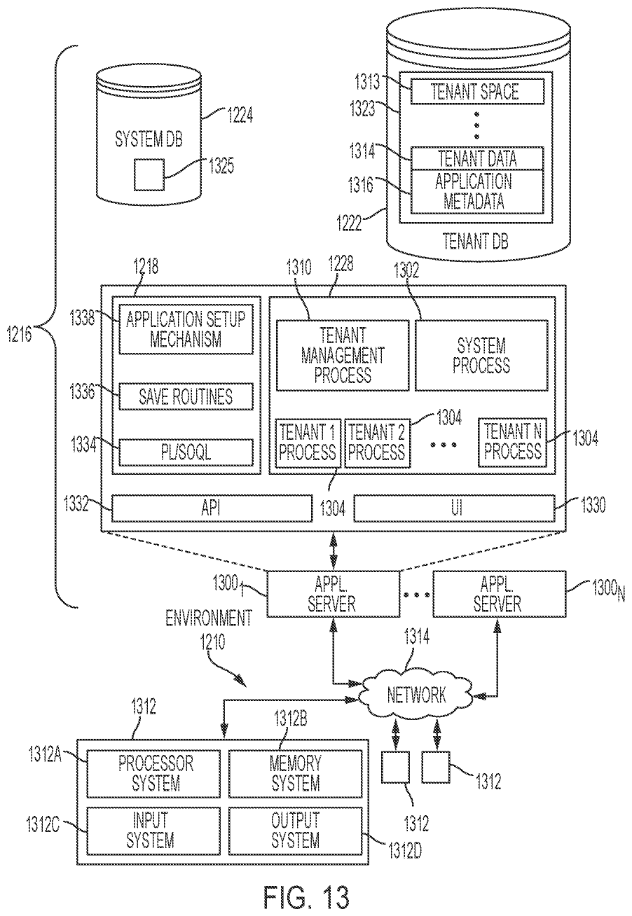

FIG. 13 shows a block diagram of example implementations of elements of FIG. 12 and example interconnections between these elements according to some implementations. That is, FIG. 13 also illustrates environment 1210, but in FIG. 13, various elements of the system 1216 and various interconnections between such elements are shown with more specificity according to some more specific implementations. Elements from FIG. 12 that are also shown in FIG. 13 will use the same reference numbers in FIG. 12 as were used in FIG. 12. Additionally, in FIG. 13, the user system 1312 includes a processor system 1312A, a memory system 1312B, an input system 1312C, and an output system 1312D. The processor system 1312A can include any suitable combination of one or more processors. The memory system 1312B can include any suitable combination of one or more memory devices. The input system 1312C can include any suitable combination of input devices, such as one or more touchscreen interfaces, keyboards, mice, trackballs, scanners, cameras, or interfaces to networks. The output system 1312D can include any suitable combination of output devices, such as one or more display devices, printers, or interfaces to networks.

In FIG. 13, the network interface 1220 of FIG. 12 is implemented as a set of HTTP application servers 1300₁-1300_{N}. Each application server 1300, also referred to herein as an “app server,” is configured to communicate with tenant database 1222 and the tenant data 1323 therein, as well as system database 1224 and the system data 1325 therein, to serve requests received from the user systems 1212. The tenant data 1223 can be divided into individual tenant storage spaces 1313, which can be physically or logically arranged or divided. Within each tenant storage space 1313, tenant data 1314 and application metadata 1316 can similarly be allocated for each user. For example, a copy of a user's most recently used (MRU) items can be stored to tenant data 1314. Similarly, a copy of MU items for an entire organization that is a tenant can be stored to tenant storage space 1313.

The process space 1228 includes system process space 1302, individual tenant process spaces 1304 and a tenant management process space 1310. The application platform 1218 includes an application setup mechanism 1338 that supports application users' creation and management of applications. Such applications and others can be saved as metadata into tenant database 1222 by save routines 1336 for execution by subscribers as one or more tenant process spaces 1304 managed by tenant management process 1310, for example. Invocations to such applications can be coded using PL/SOQL 1334, which provides a programming language style interface extension to API 1332. Invocations to applications can be detected by one or more system processes, which manage retrieving application metadata 1316 for the subscriber making the invocation and executing the metadata as an application in a virtual machine.

The system 1216 of FIG. 13 also includes a user interface (UI) 1330 and an application programming interface (API) 1332 to system resident processes to users or users at user systems 1212. In some other implementations, the environment 1210 may not have the same elements as those listed above or may have other elements instead of, or in addition to, those listed above.

Each application server 1300 can be communicably coupled with tenant database 1322 and system database 1324, for example, having access to tenant data 1323 and system data 1325, respectively, via a different network connection. For example, one application server 1300₁ can be coupled via the network 1214 (for example, the Internet), another application server 1400_{N} can be coupled via a direct network link, and another application server (not illustrated) can be coupled by yet a different network connection. Transfer Control Protocol and Internet Protocol (TCP/IP) are examples of typical protocols that can be used for communicating between application servers 1300 and the system 1216. However, it will be apparent to one skilled in the art that other transport protocols can be used to optimize the system 1216 depending on the network interconnections used.

In some implementations, each application server 1300 is configured to handle requests for any user associated with any organization that is a tenant of the system 1216. Because it can be desirable to be able to add and remove application servers 1300 from the server pool at any time and for various reasons, in some implementations there is no server affinity for a user or organization to a specific application server 1300. In some such implementations, an interface system implementing a load balancing function (for example, an F5 Big-IP load balancer) is communicably coupled between the application servers 1300 and the user systems 1212 to distribute requests to the application servers 1300. In one implementation, the load balancer uses a least-connections algorithm to route user requests to the application servers 1300. Other examples of load balancing algorithms, such as round robin and observed-response-time, also can be used. For example, in some instances, three consecutive requests from the same user could hit three different application servers 1300, and three requests from different users could hit the same application server 1300. In this manner, by way of example, system 1216 can be a multi-tenant system in which system 1216 handles storage of, and access to, different objects, data and applications across disparate users and organizations.

In one example storage use case, one tenant can be a company that employs a sales force where each salesperson uses system 1216 to manage aspects of their sales. A user can maintain contact data, leads data, customer follow-up data, performance data, goals and progress data, etc., all applicable to that user's personal sales process (for example, in tenant database 1222). In an example of an MTS arrangement, because all of the data and the applications to access, view, modify, report, transmit, calculate, etc., can be maintained and accessed by a user system 1212 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 1216 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 1216 also can maintain system level data usable by multiple tenants or other data. Such system level data can include industry reports, news, postings, and the like that are sharable among tenants.

In some implementations, the user systems 1212 (which also can be client systems) communicate with the application servers 1300 to request and update system-level and tenant-level data from the system 1216. Such requests and updates can involve sending one or more queries to tenant database 1222 or system database 1224. The system 1216 (for example, an application server 1300 in the system 1216) can automatically generate one or more SQL statements (for example, one or more SQL queries) designed to access the desired information. System database 1224 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

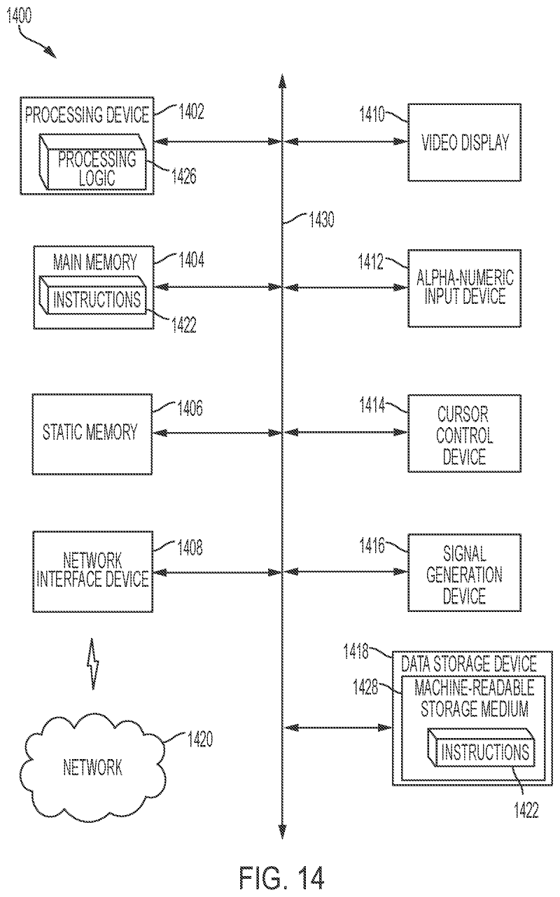

FIG. 14 illustrates a diagrammatic representation of a machine in the exemplary form of a computer system 1400 within which a set of instructions for causing the machine to perform any one or more of the methodologies discussed herein, may be executed. The system 1400 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a user system, a client device, or a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In at least one embodiment, computer system 1400 may represent, for example, elements of the cloud-based computing platform or any other elements of FIG. 1 (e.g. clients, computing systems used by the customers 150, the third-party application exchange 160) or any elements of FIGS. 12 through 14, etc.

The exemplary computer system 1400 includes a processing device (processor) 1402, a main memory 1404 (e.g., read-only memory (ROM), flash memory, dynamic random access memory (DRAM) such as synchronous DRAM (SDRAM)), a static memory 1406 (e.g., flash memory, static random access memory (SRAM)), and a data storage device 1418, which communicate with each other via a bus 1430.

Processing device 1402 represents one or more general-purpose processing devices such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1402 may also be one or more special-purpose processing devices such as an application specific integrated circuit (ASIC), a field programmable gate array (FPGA), a digital signal processor (DSP), network processor, or the like.

The computer system 1400 may further include a network interface device 1408. The computer system 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), and a signal generation device 1416 (e.g., a speaker).

The data storage device 1418 may include a computer-readable medium 1428 on which is stored one or more sets of instructions 1422 (e.g., instructions of in-memory buffer service 94) embodying any one or more of the methodologies or functions described herein. The instructions 1422 may also reside, completely or at least partially, within the main memory 1404 and/or within processing logic 1426 of the processing device 1402 during execution thereof by the computer system 1400, the main memory 1404 and the processing device 1402 also constituting computer-readable media. The instructions may further be transmitted or received over a network 1420 via the network interface device 1408.

While the computer-readable storage medium 1428 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general-purpose digital computer, by using a special-purpose computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, at least one embodiment of a system or a component may employ various integrated circuit components, e.g., memory elements, digital signal processing elements, logic elements, look-up tables, or the like, which may carry out a variety of functions under the control of one or more microprocessors or other control devices.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Any suitable programming language can be used to implement the routines of particular embodiments including C, C++, JAVA®, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiments. It should be understood that various changes can be made in the function and arrangement of elements without departing from the scope defined by the claims, which includes known equivalents and foreseeable equivalents at the time of filing this patent application.

What is claimed is:

1. A method for managing a campaign comprising:
generating a first flow template user interface (UI) for development of a first flow of a campaign for display on a display device, wherein the first flow template UI is associated with a first communication channel and comprises a first audience field, a first content field, a first scheduling field, and a first activation field including a first activation button to enable activation and deactivation of the first flow;
receiving a first target audience via the first audience field, first content via the first content field, and a first schedule via the first scheduling field;
receiving a first command to activate the first flow via the first activation button; and
transmitting the first content to the first target audience via the first communication channel in accordance with the first schedule in response to activation of the first flow.

2. The method of claim 1, further comprising:
generating a campaign initiation UI for display on the display device, the campaign initiation UI comprising a campaign owner field, a campaign name field, a campaign description field and a save/next button;
populating the campaign owner field with a user-name associated with a user identifier used to access a campaign management system configured to generate the campaign initiation UI;
receiving a campaign name via the campaign name field and a campaign description via the campaign description field; and
generating a flow creation selection UI for display on the display device responsive to selection of the save/next button, the flow creation selection UI comprising a plurality of flow creation options.

3. The method of claim 2, wherein the plurality of flow creation options comprise at least two of create from template option, create using Einstein GPT option, create from blank flow option, and install from package option.

4. The method of claim 2, further comprising:
receiving a selection create from template option from the plurality of flow creation options via the flow creation selection UI; and
generating a flow template selection UI comprising a plurality of flow templates in response to the selection of the create from template option for display on the display device.

5. The method of claim 4, wherein the plurality of flow templates comprises at least two of a blank flow, an autogenerated artificial intelligence (AI) flow, a single short message service (SMS) flow, a single email flow, a message series flow, an event sign up flow, a multi-channel flow, a lead campaign capture flow, a landing page signup flow, an abandoned cart flow, a newsletter flow, and a Trisha test flow.

6. The method of claim 4, further comprising:
receiving a selection of one of the plurality of flow templates via the flow template selection UI; and
generating the first flow template UI for the development of the first flow in accordance with the selected one of the plurality of flow templates for display on the display device.

7. The method of claim 1, wherein the first flow template user interface (UI) comprises an add flow button and the method further comprises:
in response to activation of the add flow button:
generating a flow creation selection UI comprising a plurality of flow creation options for display on the display device;
receiving a selection create from template option from the plurality of flow creation options;
generating a flow template selection UI comprising a plurality of flow templates in response to the selection of the create from template option for display on the display device;
receiving a selection of one of the plurality of flow templates; and
generating a second flow template UI for the development of a second flow in accordance with the selected one of the plurality of flow templates for display on the display device.

8. The method of claim 7, further comprising:
generating the second flow template UI, wherein the second flow template UI is associated with a second communication channel and comprises a second audience field, a second content field, a second scheduling field, and a second activation field including a second activation button to enable activation and deactivation of the second flow;
receiving a second target audience via the second audience field, second content via the second content field, and a second schedule via the second scheduling field;
receiving a second command to activate the second flow via the second activation button; and
transmitting the second content to the second target audience via the second communication channel in accordance with the second schedule in response to activation of the second flow.

9. The method of claim 1, further comprising:
receiving a campaign asset request; and
generating a campaign assets UI in response to the campaign asset request for display on the display device, wherein the campaign assets UI comprises a plurality of campaign assets designated for use in the campaign and development statuses of the plurality of campaign assets.

10. The method of claim 1, further comprising:
receiving a flow status request for the first flow; and
generating a first flow status UI for the first flow for display on the display device, the first flow status UI comprising a source template and a status of the first flow as being one of active and inactive.

11. The method of claim 1, further comprising:
receiving a campaign summary request for the campaign; and
generating a campaign summary UI in response to the campaign summary request, the campaign summary UI comprising a campaign monitoring section including a graphical representation of entries, active, and exit metrics associated with flows of the campaign and development statuses of the flows of the campaign, the flows of the campaign including the first flow.

12. A system for managing a campaign, the system comprising:
at least one processor;
a display device; and
at least one non-transitory machine-readable storage medium that stores instructions configurable to be executed by the at least one processor to:
generate a first flow template user interface (UI) for development of a first flow of a campaign for display on the display device, wherein the first flow template UI is associated with a first communication channel and comprises a first audience field, a first content field, a first scheduling field, and a first activation field including a first activation button to enable activation and deactivation of the first flow;
receive a first target audience via the first audience field, first content via the first content field, and a first schedule via the first scheduling field;
receive a first command to activate the first flow via the first activation button; and
transmit the first content to the first target audience via the first communication channel in accordance with the first schedule in response to activation of the first flow.

13. The system of claim 12, wherein the instructions are configurable to be executed by the at least one processor to:
generate a campaign initiation UI for display on the display device, the campaign initiation UI comprising a campaign owner field, a campaign name field, a campaign description field and a save/next button;
populate the campaign owner field with a user-name associated with a user identifier used to access a campaign management system configured to generate the campaign initiation UI;
receive a campaign name via the campaign name field and a campaign description via the campaign description field; and
generate a flow creation selection UI for display on the display device responsive to selection of the selectable save/next button, the flow creation selection UI comprising a plurality of flow creation options.

14. The system of claim 13, wherein the instructions are configurable to be executed by the at least one processor to:
receive a selection of create from template option from the plurality of flow creation options via the flow creation selection UI; and
generate a flow template selection UI comprising a plurality of flow templates in response to the selection of the create from template option for display on the display device.

15. The system of claim 14, wherein the instructions are configurable to be executed by the at least one processor to:
receive a selection of one of the plurality of flow templates via the flow template selection UI; and
generate the first flow template UI for the development of the first flow in accordance with the selected one of the plurality of flow templates for display on the display device.

16. The system of claim 12, wherein the first flow template user interface (UI) comprises an add flow button and the instructions are configurable to be executed by the at least one processor to:
in response to activation of the add flow button:
generate a flow creation selection UI comprising a plurality of flow creation options for display on the display device;
receive a selection of create from template option from the plurality of flow creation options;
generate a flow template selection UI comprising a plurality of flow templates in response to the selection of the create from template option for display on the display device;
receive a selection of one of the plurality of flow templates; and
generate a second flow template UI for the development of a second flow in accordance with the selected one of the plurality of flow templates for display on the display device.

17. The system of claim 16, wherein the instructions are configurable to be executed by the at least one processor to:
generate the second flow template UI, wherein the second flow template UI is associated with a second communication channel and comprises a second audience field, a second content field, a second scheduling field, and a second activation field including a second activation button to enable activation and deactivation of the second flow;
receive a second target audience via the second audience field, second content via the second content field, and a second schedule via the second scheduling field;
receive a second command to activate the second flow via the second activation button; and
transmit the second content to the second target audience via the second communication channel in accordance with the second schedule in response to activation of the second flow.

18. The system of claim 12, wherein the instructions are configurable to be executed by the at least one processor to
receive a flow status request for the first flow; and
generate a first flow status UI for the first flow for display on the display device, the first flow status UI comprising a source template and a status of the first flow as being one of active and inactive.

19. The system of claim 13, wherein the instructions are configurable to be executed by the at least one processor to
receive a campaign summary request for the campaign; and
generate a campaign summary UI in response to the campaign summary request, the campaign summary UI comprising a campaign monitoring section including a graphical representation of entries, active, and exit metrics associated with flows of the campaign and development statuses of the flows of the campaign, the flows of the campaign including the first flow.

20. A non-transitory machine-readable storage medium that stores instructions executable by at least one processor, the instructions configurable to cause the at least one processor to perform operations comprising:
generating a first flow template user interface (UI) for development of a first flow of a campaign for display on a display device, wherein the first flow template UI is associated with a first communication channel and comprises a first audience field, a first content field, a first scheduling field, and a first activation field including a first activation button to enable activation and deactivation of the first flow;
receiving a first target audience via the first audience field, first content via the first content field, and a first schedule via the first scheduling field;
receiving a first command to activate the first flow via the first activation button; and
transmitting the first content to the first target audience via the first communication channel in accordance with the first schedule in response to activation of the first flow.
